(19) United States
(12) Patent Application Publication
(10) Pub. No.: US 2012/0103371 A1
(43) Pub. Date: May 3, 2012

(54) METHOD AND APPARATUS FOR DRYING A SEMICONDUCTOR WAFER

(75) Inventors: SEOKMIN YUN, PLEASANTON, CA (US); HANCHEOL KWON, FREMONT, CA (US); GERHARD WULZ, VILLACH (AT); FREDERIC KOVACS, VILLACH (AT)

(73) Assignee: LAM RESEARCH AG, VILLACH (AT)

(21) Appl. No.: 12/914,802

(22) Filed: Oct. 28, 2010

(51) Int. Cl. B08B 3/00

(52) U.S. Cl. 134/26; 134/94.1

(57) ABSTRACT

A method and apparatus for drying semiconductor wafers uses hot isopropyl alcohol in liquid form at temperatures above 60° C. and below 82° C. The use of hot IPA better avoids pattern collapse and permits reduced consumption of IPA. The wafer temperature can be maintained by applying hot deionized water to the opposite wafer side and by evaporating the hot IPA from the wafer surface using heated nitrogen gas.

### BACKGROUND OF THE INVENTION

1. Field of the Invention

The invention relates to a method and apparatus for drying a surface of a disc-shaped article. More specifically the invention relates to a method and apparatus for drying a surface of a disc-shaped article by rinsing with an aqueous rinsing-liquid with subsequent rinsing with an organic solvent.

2. Description of Related Art

Techniques for drying a surface of a disc-shaped article are typically used in the semiconductor industry for cleaning a silicon wafer during production processes (e.g. pre-photo clean, post CMP-cleaning, and post plasma cleaning). However, such drying methods may be applied for other plate-like articles such as compact discs, photo masks, reticles, magnetic discs or flat panel displays. When used in semiconductor industry it may also be applied for glass substrates (e.g. in silicon-on-insulator processes), III-V substrates (e.g. GaAs) or any other substrate or carrier used for producing integrated circuits.

Several drying methods are known in the semiconductor industry. One type of drying method uses a defined liquid/gas boundary layer. Such drying methods are better known as Marangoni drying methods.

U.S. Pat. No. 5,882,433 discloses a combined Marangoni spin drying method, in which deionized water is dispensed onto a wafer and simultaneously a mixture of nitrogen with 2-propanol (isopropyl alcohol) is dispensed. The 2-propanol in the nitrogen influences the liquid/gas boundary layer in that a surface gradient occurs, which promotes the water running off of the wafer without leaving droplets on the wafer (Marangoni Effect). The gas dispenser directly follows the liquid dispenser while the liquid dispenser is moved from the center to the edge of the wafer and while the wafer is spun, such that gas directly displaces the liquid from the wafer. U.S. Pat. No. 5,882,433 also discloses a method where an aqueous solution is removed by an organic solution.

However, an increase of defects occurs when drying a wafer, particularly when drying the 300 mm wafers that are increasingly replacing the use of the older 200 mm wafer technology.

The ever-increasing miniaturization of the devices formed on semiconductor wafers also makes drying the wafers more difficult. This is especially so considering that, as devices formed on semiconductor wafers become smaller, their proportions do not necessarily remain the same. For example, a capacitor of reduced cell width relative to a previous generation technology will not always be proportionately less tall, in view of the need to provide adequate surface area to achieve a target capacitance. Thus, as semiconductor devices become smaller, their aspect ratio frequently increases. One can liken this to the development of real estate in Manhattan: as space in the horizontal directions becomes ever more restricted, the only direction in which to build is up.

The higher aspect ratios of ever smaller device structures contributes to the undesired phenomenon of “pattern collapse,” in which the deionized water surrounding the device structures and remaining from a rinsing step, applies a destructive force to those structures during spin drying, owing to the relatively high surface tension of the deionized water, whether drying is effected with or without a nitrogen gas flow.

### SUMMARY OF THE INVENTION

The present invention reflects the inventors' discovery that isopropyl alcohol (“IPA”) cleans and dries surfaces of disc-shaped articles much more effectively when it is heated to a temperature in excess of 60° C., and less that 82° C. (the boiling point of IPA). Although surface tension of liquids generally decreases with increasing temperature, the improved drying achieved with IPA heated to temperatures in excess of 60° C. is significantly better than would have been expected at such temperatures. Therefore, the invention may be embodied in methods for rinsing and drying disc-shaped articles following wet chemical treatment with improved prevention of pattern collapse. The invention is also embodied in an apparatus for wet processing of disc-shaped articles, equipped with components configured to provide IPA to a surface of the disc-shaped articles at temperatures in excess of 60° C. and approaching 82° C.

The invention is surprising not only in terms of the improved drying results achieved, but also in the discovery that IPA, which is combustible and has a flash point of only about 12° C., can be used safely at temperatures approaching its boiling point.

More generally, the invention provides a method for drying a plate-like article, comprising:

rinsing a plate-like article with an aqueous rinsing liquid;

after commencing said rinsing with an aqueous rinsing liquid, further rinsing the plate-like article with an organic solvent (e.g. isopropyl alcohol) that has a water content of less than 20 mass-%;

wherein the organic solvent is in liquid form and is maintained at temperatures in excess of 60° C. and less than the boiling point of the organic solvent (i.e. 82° C. at 1 bar if the organic solvent is isopropyl alcohol).

Preferred organic solvents are those that form a solution with water at least in the range of 10 mass-% to 50 mass-% of solvent to a solution in which the balance is water. The solvent therefore need not be miscible with water in all proportions, although such organic solvents are included within the scope of the invention. Preferred organic solvents are selected from the group consisting of ketones, ethers and alcohols.

The method can also be conducted at elevated pressure at 2 bar, which leads to a higher boiling temperature and thus to a higher upper limit of the organic solvent temperature.

In a preferred embodiment the organic solvent has a water content of below 10 mass-%.

In another embodiment of the method the plate-like article is rotated during rinsing with the organic solvent.

In yet another embodiment of the method the organic solvent is supplied at a volume flow in a range of 20 ml/min to 400 ml/min.

In yet another embodiment of the method the temperature of the organic solvent is maintained at temperatures above 60° C. and less than 2 K below the boiling temperature of isopropyl alcohol (i.e. 80° C. if the organic solvent is isopropyl alcohol at 1 bar). As mentioned before the boiling temperature not only depends on the kind of organic solvent used but also on the pressure at which the process is carried out.

Yet another embodiment of the method further comprises supplying heated gas to a surface of the plate-like article to promote evaporation of the organic solvent. Such a gas can be clean air but preferably is an inert gas such as a noble gas or nitrogen. Preferably the oxygen content of the used gas is below 1 mass-%.

In yet another embodiment of the method the heated gas is supplied across a surface of the plate-like article by effecting relative movement between the plate-like article and a dispensing nozzle of the gas.

In yet another embodiment of the method an amount of gas flow is decreased as the dispensing nozzle approaches a periphery of the plate-like article.

Yet another embodiment of the method further comprises applying heated deionized water to an opposite side of the plate-like article from a side to which said organic solvent is applied, in at least a peripheral region of said opposite side.

Another aspect of the invention comprises an apparatus for drying a plate-like article, which comprises:

a rinsing nozzle for rinsing a plate-like article with an aqueous rinsing liquid, and communicating with a source of aqueous rinsing liquid;

an organic solvent supply conduit communicating with a source of organic solvent, the organic solvent supply conduit comprising heating equipment adapted to heat organic solvent supplied through the conduit to temperatures in excess of 60° C. and less than boiling temperature of the organic solvent; and

an organic solvent supply nozzle configured to apply organic solvent in liquid form to a surface of a plate-like article.

In a preferred embodiment of the invention the apparatus further comprises a source of heated gas and a dispensing nozzle for directing heated nitrogen gas to a surface of the plate-like article.

In another embodiment of the invention the apparatus further comprises a source of heated water (preferably deionized water) and a dispensing nozzle for the heated deionized water that is positioned so as to apply heated deionized water to an opposite side of a plate-like article from a side acted upon by said rinsing nozzle and said organic solvent supply nozzle, in at least a peripheral region of said opposite side.

In yet another embodiment of the invention the apparatus further comprises a closed process module for receiving and processing the plate-like article, wherein said apparatus is a station for single wafer wet processing of semiconductor wafers.

In yet another embodiment said heating equipment comprises dual inline heaters configured to heat organic solvent in excess of 60° C. and less than boiling temperature of the organic solvent without overshoot to temperatures in excess of boiling temperature of the organic solvent.

### BRIEF DESCRIPTION OF THE DRAWINGS

FIG. 1 depicts schematically an embodiment of the apparatus according to the invention; and

FIG. 2 is a schematic bottom view of the nozzle assembly of FIG. 1.

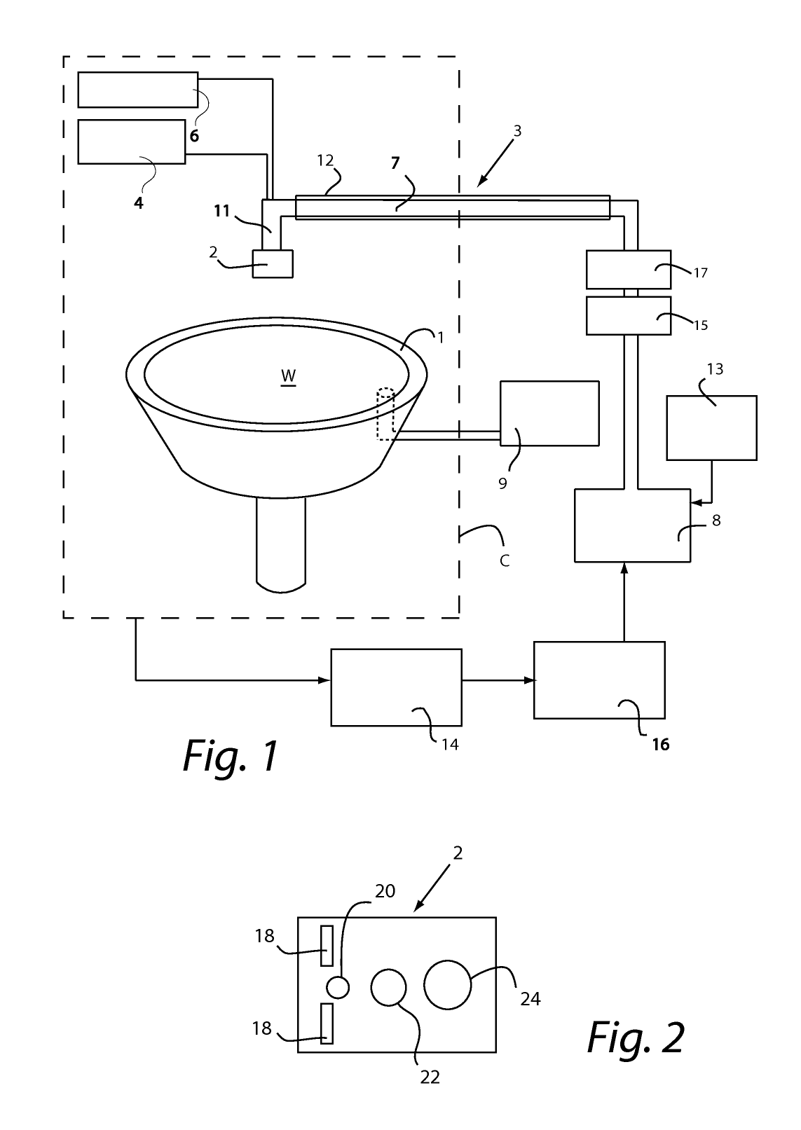

### DETAILED DESCRIPTION

Preferred embodiments of the present invention will now be described in greater detail and with reference to the accompanying Drawings. The method of the present invention comprises rinsing a plate or disc-like article with an aqueous rinsing-liquid, followed by rinsing with IPA (in liquid form), wherein the IPA preferably has a water content of not more than 20 mass-%, wherein the IPA is supplied at a temperature, which is greater than 60° C. and less than 82° C.

The aqueous solution is preferably deionized water (DI water) but can also be a diluted solution of ozone, hydrofluoric acid, hydrochloric acid, carbonic acid, or ammonia.

Subsequent rinsing means that the start of rinsing with the IPA is after the start of rinsing with the aqueous solution. This means that the rinsing with IPA can be carried out immediately after the rinsing with the aqueous solution; or there can be a passage of time between the two rinsing steps; or the rinsing with IPA can commence before the rinsing with the aqueous solution is terminated.

Advantageously the IPA has a starting water content of below 10 mass-%. This leaves a basically water-free surface, when the solvent residues evaporate. This effect is even improved when the water content of below 5 mass-% or even below 2 mass-%. As the azeotrope of IPA and water is at 87.9% by weight isopropyl alcohol and 12.1% by weight water, this connotes an IPA that is prepared by azeotropic distillation.

Once the supply of DI water is terminated, the IPA that flows off the surface of the disc may be recovered and recycled. As IPA is hygroscopic, this will result in a progressively increasing water content in the IPA unless it is supplemented with fresh IPA during this recycling.

The plate-like article is preferably rotated during rinsing with the IPA, but it can also be linearly moved. The IPA is preferably supplied at a volume flow in a range of 20 ml/min to 400 ml/min. More preferably, the flow of the IPA is not more than 200 ml/min. Indeed, at the IPA temperatures used according to the present invention, the flow of the organic solvent can be less than 100 ml/min, without generating watermarks. This is not only environmentally desired but also helps to keep the drying costs low.

In another embodiment a fluorine-containing solution (e.g. containing hydrogen fluoride, ammonium fluoride) is dispensed onto the disc-like article before the drying is conducted. Preferably such fluorine containing solution is dilute hydrogen fluoride, which is an aqueous solution with an analytical concentration of hydrogen fluoride of below 1 g/l.

Referring now to the accompanying drawing figures, reference numeral 1 denotes a spin chuck in a chamber C, which is preferably a process module for single wafer wet processing of semiconductor wafers. Chamber C is preferably a closed module so as to confine the chemicals used, including the hot IPA. A 300 mm semiconductor wafer W is positioned on the spin chuck 1 and gripped by gripping pins (not shown).

A wet process is carried out wherein different liquids are dispensed onto the wafer, through nozzle assembly 2. When dispensing the liquids the dispensing nozzle assembly can be moved across the wafer at a selected speed from the center towards the edge and back to center. This movement can be repeated as long as the respective liquid is dispensed. The spin speed during dispensing the cleaning liquids is preferably set to be in a range of 300 rpm to 2000 rpm.

First, diluted hydrofluoric acid with an HF concentration of 0.01 g/l is dispensed; second, a rinsing liquid (e.g. de-ionized water) is dispensed; third, the rinsing liquid is turned off and simultaneously the IPA supply is turned on; fourth, the organic solvent and nitrogen gas are dispensed simultaneously; and fifth a spin off step is performed.

The media arm 3 used for this process comprises a nozzle head 2, which comprises a plurality of nozzles. There is a nozzle 24 to dispense diluted hydrogen fluoride or deionized water, a nozzle 22 to dispense the hot IPA, a nozzle 20 for blowing gas (preferably nitrogen gas) onto the wafer during drying, and a pair of curtain nozzles 18 for supplying gas to the interior of chamber C so as to maintain a desired atmosphere.

The sequence for the drying method is carried out in the following order:

Step A: As a last chemical dispensing step diluted hydrogen fluoride (concentration between 1 g/l to 100 g/l) is dispensed in the wafer center for a time between 30 s to 200 s, with a flow rate of 1.7-2 l/min while the wafer is rotating at a spin-speed in a range of 500-1200 rpm (e.g. 800 rpm). The temperature of the medium is 22° C.

Step B: The rinsing step (de-ionized water) is also dispensed from DI source 6 in the wafer center for a time of 20 s, with a flow rate of 1.7-2 l/min while the wafer is rotating at a spin-speed in a range of 500-1200 rpm (e.g. 800 rpm). The temperature of the medium is 22° C.

Step C: The drying step: A nozzle-head scans the wafer once from the center to the edge at an average speed of 10 mm/s, where at the center the scanning speed is 20 mm/s and the scanning speed is decreased when moving towards the edge to 5 mm/s. During the scan, IPA is dispensed from the center till the edge of the wafer. Simultaneously nitrogen is blowing as IPA is supplied. IPA is switched off at the edge of the wafer. The IPA in this example has a temperature of 75° C.

In order to achieve stable IPA flow through the heater as well as high temperature output, it is desirable to have well-defined heating temperature range to avoid IPA boiling and possible safety failure. According to this embodiment, the IPA is supplied from a reservoir 8, and passes through dual in-line heaters 15 and 17, delivery line 7, manifold 11 before reaching nozzle head 2. By connecting two IPA heaters in series, the overall heating is stabilized, which permits increasing the heater setpoint to achieve higher IPA temperature at the outlet. By contrast, when using a single heater, a lower heating setpoint is necessary to avoid overshooting the IPA temperature setpoint.

It is also desirable, in order to achieve higher IPA temperature on the wafer, to maintain the temperature of the IPA within delivery line 7 so that the hot IPA is not cooled down during delivery. In particular, the line 7 should be kept thermally stable toward the nozzle end 2 so that any heat transfer to the line can be minimized. In this embodiment, the line is covered by heat jacket 12 to avoid temperature drop while the IPA is being delivered. The heating temperature of heat jacket should be controlled well so that the IPA temperature inside of the delivery line should be at a temperature less than its boiling point to prevent IPA bubbles from being delivered onto the wafer, which could cause significant particle defects during wafer drying.

As the wafer is processed on the spin chuck, the IPA temperature at the wafer edge would likely be cooled down significantly due to higher spin momentum at the periphery of the wafer relative to the more central regions of the wafer. Similarly, pattern collapse tends to be more severe at the edge even when using heated IPA. To avoid IPA temperature drop on the wafer, hot DI is supplied to the opposite side of the wafer from hot DI source 9, to keep the IPA temperature on the wafer uniform. Experiments conducted by the inventors have demonstrated that higher wafer temperature at the edge can be achieved compared to the normal condition where no hot DI is supplied to the backside during the process.

When IPA is used for wafer drying, nitrogen gas is typically used to remove and/or evaporate residual IPA on the wafer while spinning. Since the normal N₂ flow can cool the IPA temperature during the process, hot N₂ from hot N₂ source 4 can be used in order to minimize temperature drop and facilitate the IPA drying.

The IPA flow is preferably set between 50 ml/min to 160 ml/min. The cross-sectional area of the nozzle orifice is 8 mm² (deriving from a ⅛ inch tube). Therefore the flow velocity is in a range of between 0.1 m/s and 0.33 m/s. The hot IPA increases the wafer temperature, which dramatically decreases the number of watermarks—it is believed that this is due to a decrease of condensation because the temperature wafer surface can so be kept above the dew point of the ambient air. Nitrogen flow can be increased during the movement of the nozzle-head from the center to the edge (from 50% to 100% of the maximum nitrogen flow). At maximum (near the edge), the nitrogen flow is around 30 l/min. The chuck speed is reduced linearly from 1100 rpm to 450 rpm, while the organic-solvent-dispense-nozzle moves from the center towards the edge of the disc-like article. With the temperature of the IPA above 60° C., the flow of the IPA can be selected below 100 ml/min without generating watermarks, which can significantly reduce the consumption of IPA.

It is preferred that the hot IPA supply to the wafer W commences during the DI rinse step, rather than upon completion thereof. In particular, during the DI rinse step, heated IPA (up to 82° C., typical process is 60˜80° C.) is brought to the wafer in order to keep the wafer wet even as the DI flow is shut off. The heating setpoint of the IPA heaters 15, 17 should be kept as high as possible but should be stable to avoid heater overheat. The heat jacket 12 is also turned on and should be kept under control. The heating setpoint of heat jacket 12 also requires certain setpoint to avoid safety concern. As the drying arm 3 moves toward the wafer edge, nitrogen gas is brought to the wafer to dry the wafer. The amount of nitrogen gas flow is varied as the drying moves outwards. Once the drying arm moves out of the wafer, the wafer spins for certain time to ensure the wafer drying.

The hot DI is applied to the backside of the wafer to maintain the temperature while the heated IPA is dispensed on the top side of the wafer. The hot DI flow should be kept as low as possible in order to avoid backsplash from the chamber wall during the process. It also requires having certain flow to ensure its heat transfer to the wafer edge. While the drying arm is passing a certain position on the wafer, the hot DI should be shut off to avoid backsplash as stated above.

As the drying arm moves toward the wafer edge, heated nitrogen gas is discharged toward the wafer to dry the wafer. The temperature of the nitrogen gas is selected so as to facilitate wafer drying during the process. The amount of heated N2 flow is preferably varied as the drying moves outwards. While the drying arm is passing a certain position on the wafer, the hot DI should be shut off to avoid backsplash as stated above.

The hot IPA that flows off of the surface of wafer W may be collected in hot IPA collection area 14 and recovered in hot IPA recovery area 16, before being returned to reservoir 8. As noted above, the hygroscopic nature of IPA means that the water content thereof will gradually increase, especially when recycling is employed. To counteract that rising water content, fresh IPA may be supplied to reservoir 8 from fresh IPA source 13.

IPA whose water content has become too high to be usable may be utilized as fuel or may be re-purified by known techniques such as salting out, by which IPA and water can be separated based upon the relatively low solubility of IPA in aqueous salt solutions.

Step D: The final step is a rotation without any chemical dispense for 10 s with a rotated spin speed of 1500 rpm. Although this step is not necessary it avoids any back splashing of liquid droplets, which might adhere on the wafer backside and/or on the chuck that rotates the wafer.

While the present invention has been described in connection with various illustrative embodiments thereof, it is to be understood that those embodiments should not be used as a pretext to limit the scope of protection conferred by the true scope and spirit of the appended claims.

What is claimed is:

1. A method for drying a plate-like article, comprising:
rinsing a plate-like article with an aqueous rinsing liquid;
after commencing said rinsing with an aqueous rinsing liquid, further rinsing the plate-like article with an organic solvent having a water content of less than 20 mass-%;
wherein the organic solvent is in liquid form and is maintained at temperatures in excess of 60° C. and less than the boiling point of the organic solvent.

2. The method according to claim 1, wherein the organic solvent is selected from the group consisting of ketones, ethers and alcohols.

3. The method according to claim 1, wherein the organic solvent is an alcohol.

4. The method according to claim 1, wherein the organic solvent is isopropyl alcohol.

5. The method according to claim 1, wherein the organic solvent forms a solution with water at least in a range of 10 mass-% to 50 mass-% of solvent to a solution whose balance is water.

6. The method according to claim 1, wherein the organic solvent has a water content of below 10 mass-%.

7. The method according to claim 1 wherein the plate-like article is rotated during rinsing with the organic solvent.

8. The method according to claim 1 wherein the organic solvent is supplied at a volume flow in a range of 20 ml/min to 400 ml/min.

9. The method according to claim 1 wherein the temperature of the organic solvent is maintained at temperatures above 60° C. and less than 80° C.

10. The method according to claim 1, further comprising supplying heated gas (e.g. nitrogen) to a surface of the plate-like article to promote evaporation of the organic solvent.

11. The method according to claim 1, further comprising applying heated deionized water to an opposite side of the plate-like article from a side to which said organic solvent is applied, in at least a peripheral region of said opposite side.

12. An apparatus for drying a plate-like article, comprising:
a rinsing nozzle for rinsing a plate-like article with an aqueous rinsing liquid, and communicating with a source of aqueous rinsing liquid;
an organic solvent supply conduit communicating with a source of organic solvent, the organic solvent supply conduit comprising heating equipment adapted to heat organic solvent supplied through the conduit to temperatures in excess of 60° C. and less than boiling temperature of the organic solvent; and
an organic solvent supply nozzle configured to apply organic solvent in liquid form to a surface of a plate-like article.

13. The apparatus according to claim 12, further comprising a source of one of heated gas and heated water and a dispensing nozzle for directing heated gas or heated water to a surface of the plate-like article.

14. The apparatus according to claim 12, further comprising a closed process module for receiving and processing the plate-like article, wherein said apparatus is a station for single wafer wet processing of semiconductor wafers.

15. The apparatus according to claim 12, wherein said heating equipment comprises dual inline heaters configured to heat organic solvent in excess of 60° C. and less than boiling temperature of the organic solvent without overshoot to temperatures in excess of boiling temperature of the organic solvent.
